(19) United States
(12) Patent Application Publication
(10) Pub. No.: US 2014/0354169 A1
(43) Pub. Date: Dec. 4, 2014

(54) LIGHT EMITTING DIODE LIGHTING DEVICE

(71) Applicant: Kevin McDermott, Rockledge, FL (US)

(72) Inventor: Kevin McDermott, Rockledge, FL (US)

(21) Appl. No.: 13/906,958

(22) Filed: May 31, 2013

(51) Int. Cl. H05B 33/08

(52) U.S. Cl. CPC H05B 33/0815
USPC 315/224; 315/307; 315/297

(57) ABSTRACT

A lighting device includes an electrical circuit for energizing an LED light source having a variable illuminating resistance. The electrical circuit includes at least one target parameter, at least one target relationship and is configured for energizing the LED light source with an energizing waveform for the LED light source having a plurality of operating parameters. The operating parameters change in response to changes in ambient conditions thereby changing the performance characteristics of the LED light source. The circuit determines at least one operating parameter, compares the operating parameter with the target parameter and changes the energizing waveform applied to the LED light source for changing the effective power applied to the LED light source for maintaining the operating parameter in conformance with a target relationship with the target parameter.

### BACKGROUND

Light emitting diode (LED) lighting devices are replacing incandescent lamp lighting devices in many applications including flashlights, automotive tail lamps, buoy lights, etc. LED lamps offer high efficiency and long life in comparison with incandescent lamp lighting devices.

A standard LED has, for each application, an intensity requirement which is achieved by applying a corresponding constant DC voltage resulting in a constant DC current, resulting in a constant effective power. The intensity is selected to satisfy requirements for a specific job. To achieve the intensity regardless of the voltage of the available source of electrical power, a control circuit is designed to deliver the electrical power to the LED. In general, when supplied with the correct electrical power (correct voltage and current), the LED functions with the desired intensity. Other possible performance characteristics include longevity, candlepower, power consumption, etc.

Although LED lamps are highly efficient, approximately 40 to 80 percent of the electrical energy LED lamps consume turns into heat. The remaining electrical energy becomes emitted light. The generated heat—if not removed from within the LED at a PN junction—can permanently damage the LED.

Also, LEDs change resistance as the temperature of their PN junction changes. The variable resistance of the LED junction makes prevention of overheating or damage to the LED difficult. The variable resistance of the LED junction makes operation of the LED at a consistent (constant) intensity, color, longevity or efficiency difficult.

Also, an increase in the electrical power supplied to an LED usually creates a drop in the resistance of the LED. This drop in resistance can change the parameters of the circuit supplying power to the LED possibly causing the circuit to supply either too much or too little electrical power to the LED.

Also, LEDs are prone to damage if either the effective or the instantaneous (illuminating) power delivered by the source of electrical power exceeds the respective power limitation for the LED. Adding to the complexity of LEDs is the fact that a maximum power limitation for the LED is not always a fixed value. The maximum power limitation can change with a number of parameters including ambient temperature, thermal circuit resistance, etc.

LED lamps are typically mounted on a circuit board and within a fixture. The resulting assembly provides a thermal path (thermal circuit) for the heat to be removed from the PN junction. If the thermal circuit is inadequate—in that the thermal circuit is incapable of removing the necessary amount of heat from the PN junction—or if the thermal circuit changes such that the thermal circuit becomes inadequate, the PN junction can overheat and be damaged.

Manufacturers of LED lamps provide state-of-the-art information regarding appropriate circuit control for LED lamps. Cree Inc.—a major manufacturer of LED lamps includes—at its website (Cree.com) information regarding the thermal characteristics and circuit design parameters for LED lamps. The following information is available on the Cree, Inc. website (application note—thermal management of Cree X Lamp® LEDs and Cree XLamp® XP-E High Efficiency White LEDs). Major manufacturers of LED lamps invest substantial funds in research and development in an effort to help designers optimize the use—including the circuit design—of LED products. Therefore, an assumption that information regarding the best state-of-the-art circuitry as well as a complete analysis regarding the functioning of the LED can be found at a manufacturer's website is reasonable. Hence, the Cree, Inc. website information is relevant to the present discussion.

An LED control circuit design employs a constant voltage source or voltage regulator in a series circuit arrangement with a resistor and an LED. This arrangement energizes the LED with a preferred voltage, current and power such that the LED emits a preferred intensity of light. However, problems occur if an ambient temperature about the LED increases, in some instances. The increase in ambient temperature inhibits the flow of heat from the PN junction to the atmosphere resulting in an increase in the junction temperature. The increased junction temperature results in a decrease in the electrical resistance of the junction. Since the voltage is held constant, the decrease in the electrical resistance of the junction results in increased current flow, increasing the power supplied to the junction and therefore creating additional heat at the junction. The additional heat further lowers the electrical resistance of the junction and the scenario repeats with the junction temperature further increasing. If the initial preferred power for the LED was close to the maximum power limitation of the LED, an increase in junction temperature can result in failure. Some attempts to ameliorate the increase in junction temperature include selecting an initial power far below the maximum power limitation for the LED. However, this method of ameliorating is not desirable because the method underutilizes the ability of the LED to provide illuminating.

Another prior art design employs a battery to provide the constant voltage source. This arrangement usually employs a resistor in series with the battery and the LED to assure that the LED starts out at an initial power. If the series resistor is large enough, the resistor acts as a current limiting device. This second design substantially reduces the possibility of the LED overheating. Unfortunately, the series resistor absorbs a substantial amount of power making this design highly inefficient, in some embodiments. In addition, the initial voltage is lessened as the batteries wear down. The depletion of the batteries reduces the intensity of the LED lowering the intensity of the device such that the device is undesirable for many uses.

Still another design employs a current control circuit providing a preferred constant current for the LED. Linear Technology™ Part number LT 3447 is an example of a constant current control circuit chip. The constant current source supplies a constant current to a single LED or an array of LEDs in a series configuration, etc. If the ambient temperature increases about the LED restricting the flow of heat from the PN junction, the junction temperature will increase resulting—in a typical LED—in a decrease in junction resistance of the PN junction. If the current control circuit does not adjust and maintains the applied voltage across the LED, the current through the LED will (by virtue of a reduction in the LED resistance) increase thereby potentially overheating and damaging the LED. In order to maintain the constant preferred current as the resistance of the PN junction decreases due to an increase in ambient temperature the circuit decreases the voltage and therefore the power applied to the LED. Although the constant current control circuit does adjust the voltage waveform which energizes the LED, its adjustment in voltage is limited because it must maintain the current waveform. This limitation prevents the constant current circuit from protecting the LED junction from overheating and also prevents it from adequately controlling performance characteristics such as intensity, color and longevity.

Although the constant current circuit, in maintaining the constant current, is helpful in dealing with the problem related to an increasing ambient temperature about the LED, the constant current circuit does not adequately solve the problem. The problem is not solved because the circuit, in maintaining a constant current, does not protect the LED from overheating. For a given design configuration, a specific increase in the ambient temperature will result in a specific reduction in the magnitude of the thermal energy—heat—being removed from the PN junction by the atmosphere. The specific reduction in the magnitude of the thermal energy being removed from the PN junction causes an increase in junction temperature resulting in a specific decrease in the electrical resistance of the PN junction. Since the constant current circuit maintains a preferred current, the specific decrease in the electrical resistance of the PN junction causes a specific decrease in the voltage the circuit applies across the LED, resulting in a specific decrease in the electrical power supplied to the LED. This specific decrease in electrical power supplied to the PN junction reduces the heat added by the electric circuit to the PN junction reducing, but not offsetting, the increase in junction temperature created by the ambient temperature increase. The constant current limitation is problematic in protecting the LED from damage and also problematic in maintaining a consistent output from the LED. The constant current circuit in having the target objective of a constant current is prevented from reducing the electric power supplied to the LED by a magnitude sufficient to effect a reduction in the heat generated through the input of electrical power being equal to the reduction in the heat being removed from the LED by the thermal path due to an ambient temperature increase. Although the constant current circuit does reduce the voltage and therefore the electric power supplied to the LED junction, that reduction in voltage is stopped when the current reaches the predetermined constant current value and is therefore prevented from maintaining the illuminating resistance of the LED at a safe or at a predetermined value. The problem is caused by the nonlinear relationship between the voltage and current which exists in a typical LED. A constant current circuit does not interact with the nonlinear voltage/relationship such that the LED is protected against overheating. In addition, the requirement that the current be maintained makes it difficult for the circuit to maintain performance characteristics such as intensity, color, longevity, etc. throughout changes in resistance of the LED caused by ambient conditions.

As previously indicated, LED light sources have a variable illuminating resistance. This variable illuminating resistance makes it difficult to employ LED light sources such that their performance characteristics such as intensity, color, efficiency and longevity are acceptably maintained. The resistance of an LED light source presents additional problems as well because in addition to the resistance varying there can be a major initial resistance difference between LEDs of the same part number. For example, it is entirely possible that a first LED having an illuminating resistance of 3.2 ohms while having a current of 100 mA and a second LED of the same part number having an illuminating resistance of 3.8 ohms while having same current of 100 mA. If these two LED light sources are placed in a current controlled circuit the second LED light source will be energized with an effective energy of 118 percent of the effective energy applied to the first LED light source. This additional energy changes the illumination intensity, color and life span of the second LED light source. In addition, it can result in catastrophic overheating. Since many LED lighting devices include a plurality of individual LED lamps, this type of inconsistency and unreliability can be a major problem.

In order to avoid under powering the LED, the power for many designs is close to the maximum power (maximum junction temperature) that the LED can handle. Therefore, the LED is subject to being damaged by a small change in ambient parameters—such as ambient temperature—even when the LED is energized by a constant current circuit. A circuit design for powering an LED which has as an objective of maintaining the current at a constant value is limited in the ability to protect the LED from overheating. The constant current circuit is designed to maintain a preferred current. The constant current circuit does not seek to maintain the resistance of the LED or a parameter which is a function of the resistance of the LED as to be later described.

Yet another design for an LED control utilizing dynamic resistance of LEDs utilizes the dynamic resistance of an array of LEDs to maintain the current through the LEDs at a desired level. This dynamic resistance design is similar to the constant current circuit in which an internal current sensing resistor of a constant current microchip circuit in a series arrangement with an LED array responds to a change in its current (also the current supplied to the LED array) by creating a signal. The signal adjusts the current flowing into the load or LED array to counter the changing current and return the sensed value of the current to the constant current level. Therefore, the dynamic resistance design has the same deficit as the constant control circuit in that the dynamic resistance design does not prevent the LED from being damaged by overheating due to increases in the ambient temperature. The dynamic resistance design is limited in that the design requires an array of LED lamps with a dynamic resistance matched to the current control circuit. Finally, the dynamic resistance design does not maintain the performance characteristics such as intensity, color, longevity etc. at target levels throughout changes in the basic or illumination resistance of the LED array.

In order to properly adjust the circuit to counter increases in the ambient temperature to prevent damaging the LED, some designs add a thermally sensitive resistor (thermistor) to the circuit to interact with the current control device. An example of this design can be found in Linear Technology Corp design note 388 FIG. 6 in which auxiliary components are added to constant current control circuit LT 3474. The thermally sensitive resistor is typically mounted on the printed circuit board close to the LED and upon an increase in ambient temperature sends a signal to the current control device to change the target value of constant current to a new value of which is appropriate for the existing ambient temperature. For example, if the ambient temperature was increasing, the thermally sensitive resistor would send a signal to the current control device to reduce the target constant current to the LED to avoid damage to the LED. This system is an improvement over the basic constant current circuit as the system does initiate actions to protect the LED from overheating. However, the system is deficient in that there is a time lag—due to the separation between the PN junction of the LED and the thermistor—before the thermally sensitive resistor sends a signal to the constant current control device. In addition, the thermally sensitive resistor is not positioned precisely at the PN junction. Therefore, in some instances the system does not experience the same temperature change as the PN junction. Since the thermally sensitive resistor does not reliably experience the same temperature change as the PN junction, the thermally sensitive resistor signal to the current control device does not solve the ambient temperature problem.

Thus, all above prior art designs are defective in effectively protecting the LED from damage. All above prior art designs are also lacking in their ability to maintain a constant performance characteristics such as intensity, color, longevity etc. of the emitted light.

### SUMMARY

An LED lighting device having a circuit for energizing a variable illuminating resistance LED light source comprising one or more LED lamps with an energizing waveform. The energizing waveform can have a variety of configurations. The energizing waveform energizes the LED light source with a current waveform. The circuit includes one or more preprogrammed target parameters such as a target illuminating resistance, target effective energy, etc. for having a target relationship with a selected operating parameter such as an illuminating resistance of the LED light source. The circuit determines a value for the operating parameter defined as determining the operating parameter. A change in an operating parameter such as the illuminating resistance of the LED can result from a change in a variety of ambient conditions including an ambient temperature. The circuit is configured to effect a change in the energizing waveform to effect a change in the current waveform in response to the change in the operating parameter. The change in the energizing waveform is made to maintain the target relationship between the target parameter and the selected operating parameter. In maintaining the target relationship the circuit can help maintain selected performance characteristics of the LED lighting device such as longevity.

### BRIEF DESCRIPTION OF THE DRAWINGS

One or more embodiments are illustrated by way of example, and not by limitation, in the figures of the accompanying drawings, wherein elements having the same reference numeral designations represent like elements throughout.

FIG. 1 is a side view of a lighting device according to some embodiments.

FIG. 2 is a schematic diagram of a circuit according to some embodiments.

FIG. 3 is a schematic diagram of a circuit according to some embodiments.

FIG. 4 is a schematic diagram of a circuit according to some embodiments.

FIG. 5 is a graph of a maximum current versus an ambient temperature for an LED.

### DETAILED DESCRIPTION

A common cause of LED lamp failure results from the fact that LED lamps are damaged when a PN junction temperature exceeds a maximum value. The LED junction temperature can increase as a result of several ambient conditions including sunlight shining on the LED, an increase in the temperature of the ambient air, heat from adjacent lamps, electronic components emitting heat towards the LED or excessive electric power applied to the LED, etc. Typically, energy is added to the PN junction, by virtue of electric power applied to the PN junction. In some embodiments approximately 40-80% of the electric power supplied to the PN junction turns into heat. The remaining energy turns into light which leaves the junction as light. When equilibrium is established, the portion of the electric energy applied to the junction which turns into heat typically leaves the PN junction through thermal conduction, thermal convection and radiation.

Since, in some embodiments the LED junction is easily damaged by overheating, an LED operating at a maximum junction temperature should have its supplied electric power reduced if the ambient temperature about the LED is increased. The supplied electric power should be reduced because an increase in ambient temperature reduces the flow of heat from the PN junction eventually increasing the temperature of the PN junction. An adequate reduction in effective electrical power helps prevent the LED junction temperature from increasing such that it exceeds a safe limit. In general, if the magnitude of the reduction of electrical power supplied to the PN junction which turns into heat equals the magnitude of the reduction of heat energy leaving the PN junction through thermal conduction and other means, the temperature of the PN junction will not change.

In some embodiments, the variable resistance of the LED creates problems when energizing a lighting device having an LED light source. Upon being energized, the PN junction of the LED receives energy from the electrical control circuit and disposes that energy through emitted light and emitted heat. Although heat is removed from the LED by radiation, convection and conduction, typically most of the heat is removed by conduction. The temperature of the PN junction becomes stabilized when the energy supplied by the electrical control circuit equals the sum of the emitted light energy plus the removed heat energy. If the energy from the electrical control circuit supplied to the PN junction exceeds the outgoing energy the temperature of the PN junction increases until equilibrium is achieved.

The temperature of the PN junction will increase if the effective electrical power supplied to the LED by the control circuit increases because an increase in electrical power increases the energy input to the PN junction. The PN junction temperature will also increase if the ambient temperature surrounding the LED increases as an increase in ambient temperature would reduce the transmission of heat energy from the PN junction. In some embodiments, the PN junction temperature also increases if adjacent circuit components emit heat, resulting in a reduction of the heat that can be transmitted from the PN junction towards that nearby circuit component. In some embodiments, the PN junction temperature also increases if the LED is subjected to bright sunlight or adjacent components which direct energy towards its PN junction. In some embodiments, the PN junction temperature also increases if the thermal resistance between the PN junction and the ambient increases due to a shifting of components, oxidation, etc. Thus, in some embodiments, there are many ambient conditions which can cause the temperature of the PN junction to increase.

In some embodiments a typical 3 watt LED, could have a maximum PN junction temperature of 150° C. As the temperature of that PN junction increases towards 150° C., the PN junction resistance typically decreases. If the temperature of the PN junction continues to increase beyond 150° C., in some embodiments the PN junction will overheat. The PN junction resistance will increase and the LED will be permanently damaged. Presently, there is no easy, accurate, economical and acceptable way to measure the junction temperature of LEDs employed in a typical commercial circuit. Hence, since almost every performance metric of an LED light source is a function of the PN junction temperature there is no easy or accurate way to control the performance characteristics of an LED light source and protect its PN junction from overheating without employing an operating parameter which is a function of the temperature. In some embodiments the present invention employs the illuminating resistance of the LEDs light source as an indicator of the temperature of the PN junction. The present invention also determines the illuminating resistance by measuring voltages and employs a current sensing resistor to calculate the illuminating resistance while the circuit energizes the LED light source. In some embodiments the present invention repeatedly determines operating parameters such as illuminating resistance at a high frequency and controls these parameters to manage the performance characteristics of the LED light source.

The term energizing waveform within this application describes the waveform of voltage versus time which is applied by the circuit to the LED light source. A common energizing waveform is a constant voltage versus time waveform. Alternate energizing waveforms can have any of a variety of contours including, but not limited to: pulse width modulated PWM contours and varying voltage waveforms. A specific energizing waveform of a voltage when applied to an LED light source energizes the light source with a specific current waveform. In some embodiments, a constant current waveform would represent the current through an LED energized by a constant voltage waveform.

The term operating parameter or basic operating parameter within the present application defines a circuit parameter which has an instantaneous value determined/calculated by the circuit while the LED light source is energized by an energizing waveform. In some embodiments, operating parameters include voltages, effective power, illuminating power, currents, etc. at a variety of locations within the circuit including both parameters which are not functions of the illuminating resistance of the LED light source, i.e., parameters which do not change as a result of changes in the illuminating resistance of the LED light source, and parameters such as resistive operating parameters which are functions of the illuminating resistance of the LED light source and which do change when the illuminating resistance of the LED light source changes.

The term resistive operating parameter within the present application defines a circuit parameter which is a type of operating parameter. The resistive operating parameter has a value which is able to vary. An instantaneous value of the resistive operating parameter is determined/calculated by the circuit while the LED light source is energized by an energizing waveform. In some embodiments, resistive operating parameters include illuminating resistance (R), illuminating power (I²R), effective power (I²R), etc. A resistive operating parameter is a function of the illuminating resistance of the LED light source whereby, changes in the illuminating resistance of the LED light source directly change the value of each of the resistive operating parameters within a circuit. In contrast, changes in the illuminating resistance of the LED light source do not necessarily change the value of operating parameters (basic operating parameters). Resistive operating parameters can incorporate operating parameters which are not functions of the illuminating resistance of the LED as long as the resistive operating parameter remains a function of the illuminating resistance, in some embodiments.

In some embodiments, the circuit monitors at least one selected operating parameter and adjusts the energizing waveform applied to the LED light source to effect a change in the current waveform representing the current passing through the LED light source to maintain the selected operating parameter at a target relationship with a target parameter. In some embodiments, when a determined/calculated illuminating resistance is different from a related target illuminating resistance the illuminating resistance is adjusted through a change in the energizing waveform to bring the determined illuminating resistance towards, in conformance with, the target illuminating resistance.

In some embodiments, when the illuminating power of an LED light source (a resistive operating parameter) differs from the target illuminating power, the circuit adjusts the energizing waveform to maintain the illuminating power at the value defined by the target illuminating power

In some embodiments, the same procedure can be employed to maintain other resistive operating parameters including illuminating resistance, effective power, etc. at respective related target parameters. In some embodiments the illuminating resistance of an LED is the dynamic illuminating resistance of the LED.

A target relationship within the present application defines any of a variety of relationships that are able to be established between one or more operating parameters of the energized circuit and one or more target parameters programmed into the circuit. A target relationship refers to an instantaneous relationship between an instantaneous value of an operational parameter in an energized circuit and a target parameter programmed into the circuit. A target relationship refers to the relationship that the circuit is designed to maintain. In some embodiments, the target relationship requires the operating or illuminating resistance to be equal to the target illuminating resistance.

In some embodiments, the target relationship requires the illuminating power to be maintained at a target illuminating power until such time as the illuminating resistance drops below a target illuminating resistance whereat the circuit reduces the target illuminating power to a new target illuminating power of a reduced magnitude or value. Since the illuminating power of an LED is a function of the illuminating resistance (I²R) the circuit can monitor and control the illuminating resistance and employ a microcontroller to make determinations of the illuminating power for maintaining the illuminating power at the target illuminating power. The circuit upon determining that the illuminating resistance has dropped below a target illuminating resistance changes the target illuminating power, in some embodiments.

If the circuit is energized and the operating relationship differs from the target relationship, the circuit will adjust the energizing waveform such that the operating relationship is in conformance with the target relationship. In some embodiments, when an operating parameter is not in conformance with a target relationship the circuit adjusts the energizing waveform to effect a change in the current waveform to maintain the operating parameter in conformance with the target parameter. The circuit adjusts the energizing (voltage) waveform to effect a change in the current waveform because adjusting both the voltage and the current waveforms represent the most effective way of controlling operating parameters, in some embodiments. Adjusting the energizing voltage waveform thereby adjusting the current waveform is beneficial when dealing with non-linear voltage\current profiles as found in a typical LED, in some embodiments.

In some embodiments, when the illuminating resistance drops below a target minimum safe illuminating resistance the circuit will adjust the energizing waveform such that the illuminating resistance is equal to or above the target minimum safe illuminating resistance.

In some embodiments, the circuit adjusts the energizing waveform upon a difference between the illuminating resistance and a target illuminating resistance of less than four tenths of an ohm.

In some embodiments, the circuit adjusts the energizing waveform upon a difference between a first illuminating resistance and a second illuminating resistance of less than four tenths of an ohm.

In some embodiments, the varying PN junction resistance (varying illuminating resistance) of an energized LED light source creates many problems for the circuit designer in his attempt to the LED light source at its maximum output and in a manner that does not precipitate an excessive PN junction temperature causing overheating failure. The inability to measure the junction temperature of LED lamps in everyday circuits is a limitation in the effort to protect the LED lamps from overheating. The LED has a variable illuminating resistance and this resistance varies depending upon a number of parameters which can vary including ambient temperature, the thermal circuit, the effective electrical power applied to the LED, etc. At any point in time, the instantaneous calculated value of the variable illuminating resistance of the LED would indicates an illuminating resistance of a fixed value. The circuit to be later described uses the concept that the variable illuminating resistance of the PN junction is able to be economically determined for a single LED lamp or for a plurality of LED lamps in a circuit and that the determined illuminating resistance is able to be employed as an indicator of the condition and temperature of the PN junction. In some embodiments, the circuit employs one or more current sensing resistors and circuit voltages to estimate the illuminating resistance of the PN junction of a single LED. In some embodiments, the circuit energizes an LED light source comprising a single LED or comprising a plurality of LEDs in a series or other circuit arrangement with each LED of the group having a variable illuminating resistance. In those embodiments having a series arrangement, determining the illuminating resistance of the plurality of LEDs by dividing the illuminating voltage of the plurality of LEDs by the illuminating current of the plurality of LEDs is possible. These determinations are achieved by a microcontroller within the circuit, in some embodiments. Other LED assemblies having a mixture of series and parallel groupings have the assembly illuminating resistance determined by the circuit using classical circuit analysis programmed into a microcontroller. In some embodiments, the measurements, which are typically taken with high frequency, permit the circuit to determine operating parameters including: effective power, illuminating power, illuminating resistance etc.

In some embodiments, the circuit is programmed with target parameters such as a target illuminating resistance or a target range of illuminating resistance extending from a target minimum illuminating resistance to a target maximum illuminating resistance. In lieu of programming the circuit with the target illuminating resistance, in some embodiments, the circuit employs resistors for establishing the target illuminating resistance. In some embodiments, the circuit is preprogrammed with one or more target parameters including but not limited to: target illuminating resistance, target effective power, target illuminating power, or other suitable target parameters. In some embodiments, the circuit is preprogrammed with a target relationship and configured to maintain the target relationship between an operating circuit parameter such as the calculated instantaneous value of the variable illuminating resistance (the illuminating resistance) and a target parameter such as a target illuminating resistance.

In some embodiments, maintaining the illuminating resistance of the LED light source at a target illuminating resistance has the effect of maintaining the PN junction at a target junction temperature which helps in maintaining the performance characteristic of the LED of emitted relative color at a target value. In some embodiments, maintaining the relative color of emitted light the circuit also requires maintaining the waveform of the forward current passing through the LED. Although it is not always possible to completely control both the illuminating resistance and the current waveform such that the emitted relative color is precisely maintained, the present circuit includes a target relationship requirement which supports that objective, in some embodiments.

In some embodiments, maintaining the illuminating resistance of the LED light source at a target illuminating resistance has the effect of maintaining the PN junction at a target junction temperature which helps in maintaining the relative luminous flux at a target value. In some embodiments, for maintaining the relative luminous flux at a target value the circuit also requires maintaining the waveform of the current passing through the LED at a target value. Although it is not always possible to completely control both the illuminating resistance and the waveform of the current such that the luminous flux is precisely maintained, the present circuit includes a target relationship requirement which supports that objective, in some embodiments.

In some embodiments, maintaining the illuminating resistance of the LED light source at a target resistance has the effect of controlling the longevity of the LED.

In some embodiments, the predetermined target relationship to be maintained is the illuminating resistance at a target illuminating resistance and for those embodiments if the resistances are equal, no action is taken. Since no two operational parameters can be exactly equal the use of the term equal within the present application indicates that the difference between the two operational parameters does not exceed a magnitude determined by the circuit. However, if the illuminating resistance is different than the target illuminating resistance, the circuit changes the energizing waveform to effect a change in the current waveform to adjust the effective power to the LED light source. This adjustment in effective power input to the PN junction adjusts the temperature of the PN junction and consequently the PN junctions illuminating resistance. In some embodiments this adjustment process is continuously and quickly repeated thereby maintaining the illuminating resistance at the target illuminating resistance. In some embodiments, the illuminating resistance is not brought back to the exact value of the target illuminating resistance; however the illuminating resistance is brought back to a resistance that is sufficiently close to the target illuminating resistance such that the circuit effectively achieves the objective of maintaining the illuminating resistance at the target illuminating resistance.

In some embodiments, the circuit design the illuminating resistance of the LED light source and adjusts the energizing waveform to maintain the illuminating resistance at the target illuminating resistance by adjusting the effective energy to counter changes in the illuminating resistance of the LED light source caused by changes in ambient conditions such ambient temperature. If, for example, the ambient temperature increases, the increase would result in a lowering of the illuminating resistance of the LED light source. However, in some embodiments the circuit quickly senses the lowering of the illuminating resistance and responds by decreasing the effective power supplied to the LED to counter the illuminating resistance lowering caused by the change in ambient temperature and to bring the illuminating resistance back towards the target illuminating resistance. The circuit therefore maintains the illuminating resistance at a target value. In some embodiments the circuit protects the LED light source from permanent thermal damage because the prelude to permanent thermal damage is a drop in the illuminating resistance below a threshold value (a minimum threshold illuminating resistance), in some instances. Since in some embodiments, the target illuminating resistance is set at or higher than the minimum threshold illuminating resistance, and in some embodiments, the minimum threshold illuminating resistance is an indicator that the condition of the PN junction is approaching failure the circuit in maintaining the illuminating resistance at or very near the target illuminating resistance helps prevent the PN junction from overheating.

In some embodiments another operational scenario occurs wherein the ambient temperature decreases. In this scenario the decrease in ambient temperature increases the flow of heat from the PN junction thereby decreasing the temperature of the PN junction and thereby increasing illuminating resistance of the PN junction. In this scenario, the circuit responds by changing the energizing waveform for increasing the power applied to the PN junction thereby increasing the temperature of the PN junction causing a decrease in the illuminating resistance such that the illuminating resistance value returns to the target illuminating resistance. In maintaining one or more operating circuit parameters at a target relationship with their target parameters the circuit, in some embodiments, maintains selected performance characteristics at their target values.

In some embodiments, the LED light source is energized with a control system (constant voltage power supply, constant current power supply, etc.) and the circuit interferes with the functioning of the control system only when an operating parameter such as the illuminating resistance of the LED light source is not in conformance with the target relationship programmed into the circuit. In some embodiments, the circuit is programmed with the target relationship. In some embodiments, the target relationship is the illuminating resistance equal to the target illuminating resistance. The circuit has a single target relationship or any combination of a variety of predetermined target relationships with each relationship determined by the target performance characteristic of the LED light source.

In some embodiments, the LED light source is energized with a control system and the circuit only interferes with the control system when the illuminating resistance of the LED light source is exterior to a target range of illuminating resistance or is not conforming to a target relationship with the target range of illuminating resistance. The target range of illuminating resistance extends from a minimum illuminating resistance to a maximum illuminating resistance included in the circuit. If the illuminating resistance of the LED was changed by an environmental condition, such as ambient temperature, and the change placed the illuminating resistance exterior to the target range of illuminating resistance, the circuit would adjust the energizing waveform and effective power applied to the LED light source to return the illuminating resistance such that the illuminating resistance was within the target range, in some embodiments.

In some embodiments, the circuit and the LED light source represent a portion of a larger circuit arrangement of LEDs which includes auxiliary light emitting diodes LEDs that do not have variable illuminating resistances measured or controlled by the present circuit.

In some embodiments, the circuit and the LED light source represent a portion of a larger circuit arrangement which includes auxiliary light emitting diodes LEDs that do not have variable illuminating resistances determined by the circuit; however the effective power supplied to these auxiliary light emitting diodes is adjusted based upon the measured illuminating resistance of the LED light source.

FIG. 1 is a side view of a lighting device 1 according to some embodiments. Lighting device 1 includes a circuit board 2 mounted on a cylindrical base 3. Circuit board 2 includes a circuit 10. Cylindrical base 3 includes a power supply PS (not shown).

References within this application regarding illuminating parameters including; illuminating resistance, illuminating current, illuminating voltage, illuminating power, etc. refer to those operating parameters of the light emitting diode LED light source determined when the light emitting diode LED light source is conducting electricity and emitting light.

A determination regarding an operating parameter includes determining the magnitude or value of the operating parameter. The determination is made by the circuit measuring or sensing voltages within the circuit and then calculating and finally determining the value of the operating parameter. If the operating parameter is a constant (has a constant value), then a single determination would be an accurate representation of that value. However, if the operating parameter is a variable, then the determination is made, in some embodiments, by making a plurality of instantaneous determinations of the operating parameter and subsequently averaging those instantaneous determinations. The average value is then used as the determination of that operational parameter. If all of the operating parameter waveforms within a circuit are represented by constants and the LED light source is continuously emitting light then the illuminating, instantaneous and average values will be substantially equal

In some embodiments in which operating parameters have a pulsing or varying waveform, determinations of illuminating parameters are made only within each “ON” pulse or “ON” zone of the waveform. In some embodiments, accuracy for a determination of a parameter is improved if multiple determinations are made each within a separate “ON” pulse of a pulsing waveform or “ON” zone of a varying waveform. An average of the plurality of determinations is then used as the determination of the parameter. In some embodiments, accuracy is further improved if several determinations of the parameter are taken within each “ON” pulse or “ON” zone and repeated for a plurality of “ON” pulses or “ON” zones with all of the determinations averaged and used as the determination for that parameter. In some embodiments, single determinations of the illuminating operating parameters are taken during the time the light emitting diode LED is emitting light—“ON” pulse or “ON” zone and at an appropriate time within the “ON” pulse or “ON” zone such that the single measurement is indicative of the value of the illuminating parameter during the pulse. The waveform of the operating parameters can has a variety of contours, in some embodiments. Selecting the proper location within a waveform for determining the operating parameter with a single determination is facilitated by viewing the waveform with an oscilloscope, in some embodiments. In some embodiments, once the waveform is charted by an oscilloscope basic mathematical integration techniques are used to identify the appropriate location for a single determination measurement for determining an operational parameter. In some embodiments, a microcontroller is programmed by one skilled in the art to make the required determinations at the appropriate location of the waveform.

In some embodiments the present circuit analyzes and employs two types of power. The first type of power is illuminating power which, as previously described, is the power being supplied to the LED when the LED is illuminating or “ON”.

The second type of power is effective power which is the average power supplied to the LED light source over a typical period of time. In some embodiments, the average power supplied to the LED light source is determined by taking a plurality of instantaneous measurements at substantially equal increments of time throughout a time zone of a varying waveform or throughout a period of a pulsing waveform, with each measurement determining an instantaneous power the plurality of instantaneous measurements are then averaged to determine the effective power. In some embodiments, in addition to the measurements taken within the periods or time zones the instantaneous power determinations are additionally taken throughout a plurality of periods or time zones and then averaged to determine the effective power. Unlike the measurements taken to determine illuminating power, the measurements for the determination of effective power are taken without regard to the illuminating status of the LED light source. Effective power multiplied by a time span represents the total amount of electrical energy being supplied to the LED light source over the time span. In some embodiments, energy is supplied to the LED light source in the form of an energizing waveform having a varying voltage. In some embodiments in which the LED light source is energized with a pulsing waveform with “ON & OFF” zones, some of the instantaneous determinations of effective power indicate that no instantaneous power is being supplied. Effective power is important because in some embodiments the circuit adjusts the energizing waveform to adjust the effective power being delivered to the LED light source as a means to maintain a target relationship between an operating parameter and a related target value of that operating parameter.

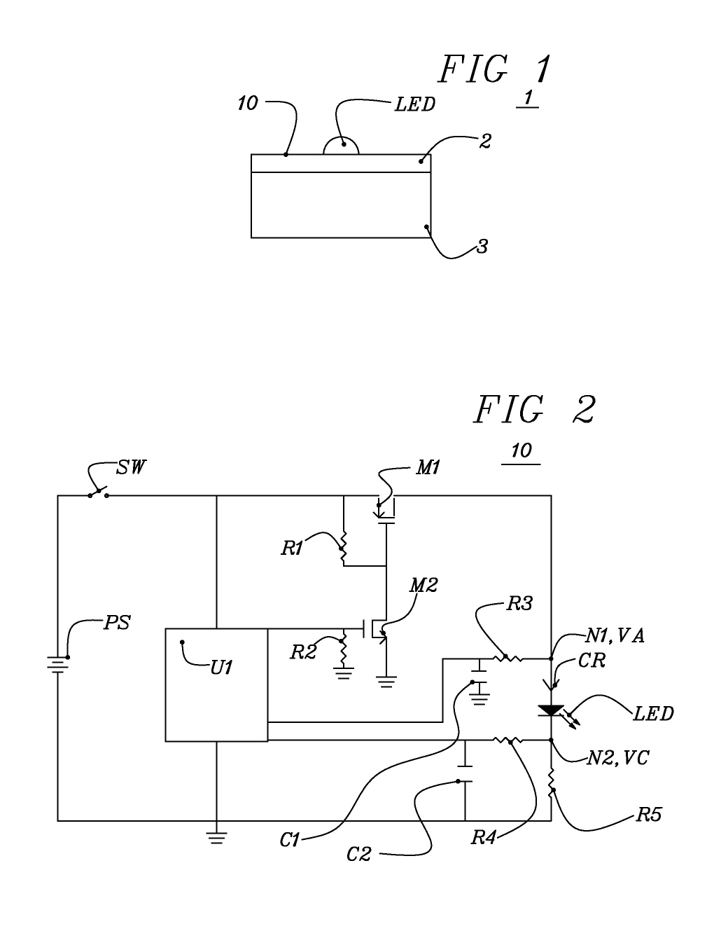

FIG. 2 is a schematic diagram of circuit board 10 from FIG. 1 according to some embodiments. Circuit 10 comprises a microcontroller U1 used to determine and control the energizing waveform applied to light emitting diode LED, illuminating resistance of light emitting diode LED, the illuminating voltage, the illuminating current and any of a variety of operating parameters related to light emitting diode LED. In some embodiments, microcontroller U1 comprises part number PIC12F1822 Mfr. Microchip Inc. In some embodiments, light emitting diode LED comprises part number XPEW HT-L1-0000-00E01 Mfr. Cree Inc. Light emitting diode LED has a variable illuminating resistance with the resistance changing in response to ambient temperature, power input, thermal resistance of the PN junction, etc. Microcontroller U1 includes an ADC (Analog to Digital Converter), a PWM (Pulse Width Modulation) Module, and sufficient I/O (Input/Output) ports to operate circuit 10. Microcontroller U1 is preprogrammed with a plurality of target parameters including but not limited to target maximum illuminating power and a target maximum effective power that can be supplied to light emitting diode LED. Microcontroller U1 is also preprogrammed with target parameters including but not limited to target maximum illuminating resistance, target minimum illuminating resistance, and target illuminating resistance for light emitting diode LED. In some embodiments, microcontroller U1 is programmed with target relationships to be maintained between operational parameters and target parameters of circuit 10. For some circuit 10 configurations, the preprogramming of microcontroller U1 does not include all of the above mentioned parameters for other configurations the program includes additional parameters. Other microcontrollers having more or less functions or capacities are utilized to control circuits having more or less requirements, in some embodiments. One skilled in the art of programming would be able to create code to properly function within circuit 10 as described herein. Circuit 10 further comprises power source PS, used to power circuit 10. In some embodiments, power source PS is a 4.5 volt power supply. A switch SW is used to energize circuit 10 with power source PS to apply an energizing waveform to light emitting diode LED. A transistor M1, a transistor M2, a resistor R1, and a resistor R2 are used to create a high side switch controlled by microcontroller U1. In some embodiments, transistor M1 comprises part number NDS332P Mfr. Fairchild Semiconductor. In some embodiments, transistor M2 comprises part ZXMN2A01E6TA Mfr. Zetex Inc. In some embodiments, resistor R1 is a 1K ohm resistor number. In some embodiments, resistor R2 is a 10K ohm resistor. Resistor R1 and resistor R2 are pull-up and pull down resistors, respectively. A resistor R5 is used to sense an illuminating current CR flowing through light emitting diode LED. In some embodiments, resistor R5 is a 0.2 ohm resistor. Resistors R3 and R4, and capacitors C1 and C2 form an input filter configured to aid microcontroller U1 in sensing an illuminating anode voltage VA at a node N1 and an illuminating cathode voltage VC at a node N2. In some embodiments, resistors R3 and R4 are 6.2 K ohm resistors. In some embodiments, capacitors C1 and C2 are 0.1 μf capacitors. In operation, when switch SW is closed, circuit 10 is energized with power source PS whereupon microcontroller U1 begins operating. Microcontroller U1 senses illuminating anode voltage VA at node N1 and illuminating cathode voltage VC at node N2. Using this information and other information from a plurality of circuit parameters microcontroller U1 determines illuminating current CR which is the current flowing through light emitting diode LED and resistor R5. Microcontroller U1 also calculates the illuminating power, the effective power and the illuminating resistance of light emitting diode LED.

Microcontroller U1 compares the operating parameter of illuminating resistance with target illuminating resistance because the target relationship programmed into circuit 10 is the illuminating resistance of light emitting diode LED is to be maintained at target illuminating resistance for light emitting diode LED. Because of that target relationship, if microcontroller U1 identifies a difference between illuminating resistance and target illuminating resistance (the illuminating resistance determined by the circuit is not conforming to the target relationship with the target illuminating resistance), microcontroller U1 sends signal S1 to change the energizing waveform. This causes a change in the current waveform of the current energizing light emitting diode LED and changes the effective power applied to light emitting diode LED. In some embodiments, signal S1 is a PWM signal. Circuit 10 uses microcontroller U1 to create PWM signals to adjust the energizing waveform applied to the LED to change the effective power and therefore the illuminating resistance of the LED to maintain the illuminating resistance (operational parameter) at a target illuminating resistance (conforming to a target value). In some embodiments, signal S1 is not a PWM signal but has a different configuration for adjusting the energizing waveform applied to light emitting diode LED. Based upon a target illuminating resistance (target parameter) of light emitting diode LED and in order to assure that light emitting diode LED is energized with the effective power sufficient to maintain the illuminating resistance at (target relationship) target illuminating resistance, microcontroller U1 adjusts a duty cycle of signal S1 to change the energizing waveform supplied to light emitting diode LED to bring illuminating resistance to target illuminating resistance. If the illuminating resistance is less than target illuminating resistance, indicating too much power is being delivered to light emitting diode LED, microcontroller U1 decreases the duty cycle of PWM signal S1 thereby changing the energizing waveform to reduce the effective power supplied to light emitting diode LED. If a difference exists, such as the illuminating resistance is more than target illuminating resistance indicating that light emitting diode LED is underpowered and more power is required, microcontroller U1 increases the duty cycle of signal S1 thus changing the energizing waveform to increase the effective power supplied to light emitting diode LED. Thus, Circuit 10 employs the energizing waveform to energize light emitting diode LED at the effective power sufficient to maintain the illuminating resistance at the target illuminating resistance throughout variations in ambient temperature. Circuit 10 does not necessarily maintain the current passing through the LED at a constant value. Therefore, changes in the energizing waveform are made without the constant current limitation permitting those changes to be more effective in controlling selected operating parameters, in some embodiments. The Illuminating resistance is therefore more effectively maintained in conformance with the target relationship with the target illuminating resistance.

Circuit 10 provides options regarding how and if the effective power applied to the LED is changed. In the above mentioned example, the energizing voltage waveform is adjusted to adjust the effective power whenever the illuminating resistance of the LED is not equal to the target illuminating resistance. However, in some embodiments, circuit 10 adjusts the effective power when the illuminating resistance of the LED, as determined by microcontroller U1, drops below a target minimum illuminating resistance acceptable for the LED. Other embodiments adjust the effective power when the illuminating resistance of the LED exceeds a target maximum illuminating resistance acceptable for the LED.

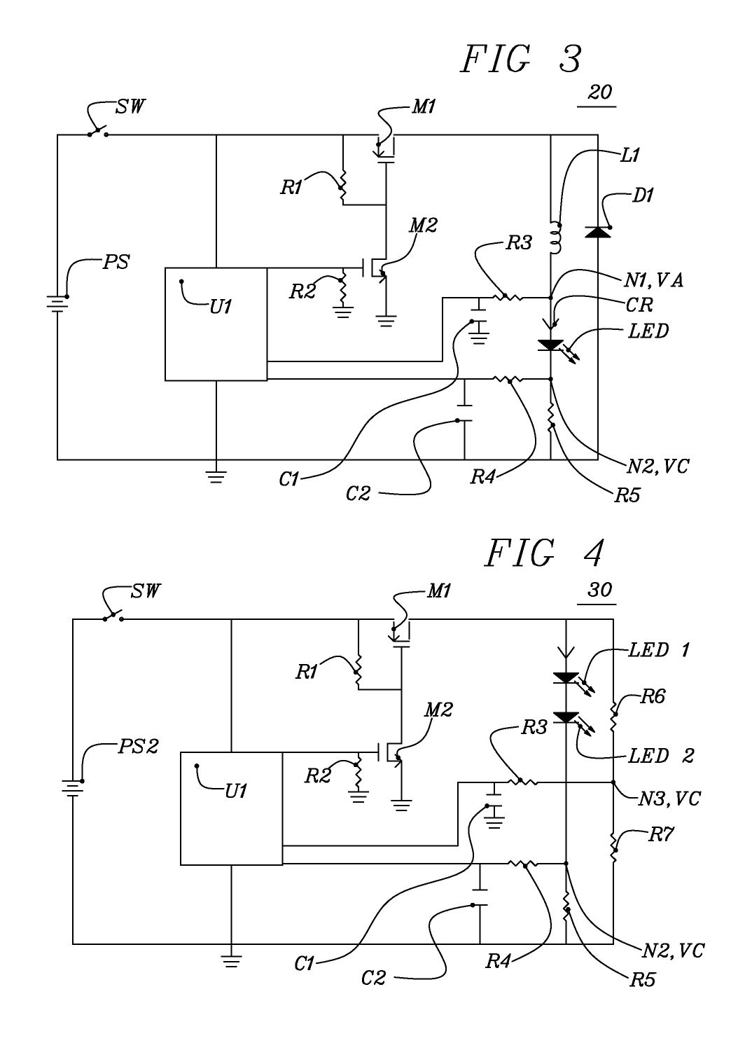

FIG. 3 is a schematic diagram of a circuit 20 according to some embodiments. In some embodiments, circuit 20 is used in place of circuit 10 of FIG. 2. Circuit 20 is similar to circuit 10 with the addition of a feedback loop, including an inductor L1 and a diode D1. In some embodiments, inductor L1 comprises a 100 micro Henry part number SDR1005-101KL Mfr. Burns, Inc. In some embodiments, diode D1 comprises part number DFLS14OL Mfr. Diodes, Inc. Inductor L1 dampens the peak current and stores the energy when the voltage from power supply PS is higher than the voltage sufficient to power light emitting diode LED to achieve a target illuminating resistance RT. Diode D1 is included in the feedback loop to continue the flow of current through light emitting diode LED and discharge inductor L1 when transistor M1 and transistor M2 are switched off to thereby utilize the energy stored in inductor L1. The feedback loop of circuit 20 increases the efficiency of circuit 10 and increases the light output of light emitting diode LED, in some embodiments.

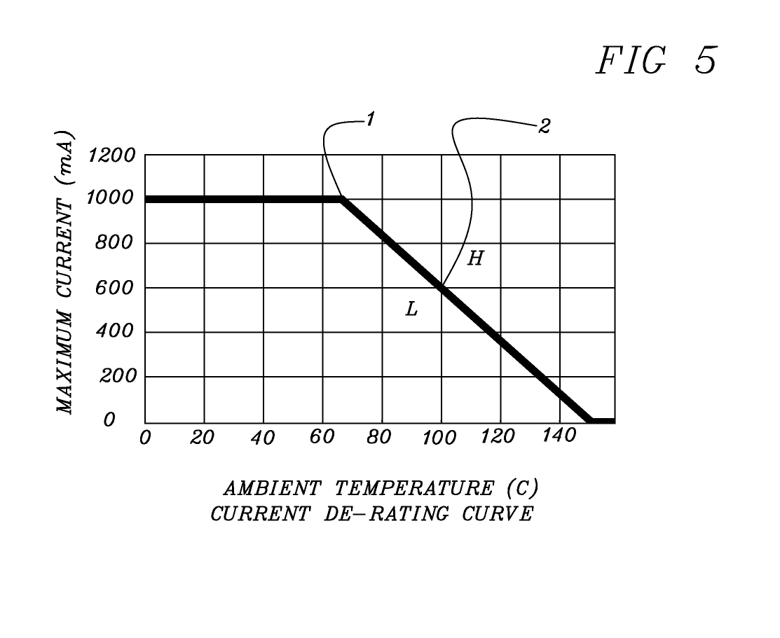

FIG. 4 is a schematic diagram of a circuit 30 according to some embodiments. Circuit 30 functions similar to circuit 10 of FIG. 2, except circuit 30 is energizing an LED light source LS having two LEDs including a light emitting diode LED1 and a light emitting diode LED2, in place of the single light emitting diode LED of circuit 10. In some embodiments, LED 1 and LED 2 can be considered as an LED light source. In some embodiments, an LED light source is a single LED as found in FIG. 1 or an LED light source is a plurality of LEDs arranged in a series, parallel or any other acceptable circuit arrangement. In some embodiments, when an LED source having a plurality of LEDs is employed, operating parameters including the illuminating resistance, effective power, illuminating voltage, etc. are each measured as if the plurality of LEDs were a single LED. In some embodiments, circuit 30 is substituted for circuit 10. Circuit 30 also includes a power source PS2 in place of power source PS of circuit 10. Light emitting diode LED1 and light emitting diode LED2 are each substantially equal to light emitting diode LED of circuit 10. In some embodiments, power source PS2 is a 6 volt power supply. Circuit 30 further comprises a resistor R6 and a resistor R7 which form a voltage divider network designed so that the voltage at a node N1 is double the value of the voltage at a node N3. In some embodiments, resistor R6 is a 10 K ohm resistor. In some embodiments, resistor R7 is a 10K ohm resistor. The ratio between the voltage at node N1 and the voltage at node N3 is used so that the maximum voltage at the input pin of microcontroller U1 is not exceeded. The ratio is employed to help microcontroller U1 by limiting a voltage handled by the microcontroller. Microcontroller U1 calculates the combined variable illuminating resistance of light emitting diode LED1 and light emitting diode LED2. Microcontroller U1 controls the combined illuminating resistance of the plurality of LEDs in the same way that circuit 10 controlled the illuminating resistance of the single light emitting diode LED. Circuit 30 measures and adjusts the illuminating resistance and effective power supplied to light emitting diode LED1 and light emitting diode LED2 in circuit 30 as if the light emitting diodes were a single light emitting diode in a similar manner as circuit 10 adjusts those parameters for the single light emitting diode LED, in some embodiments. Circuit 30 treats light emitting diode LED 1 and light emitting diode LED2 as a single entity; hence the combined illuminating resistance is maintained at a target illuminating resistance with the target illuminating resistance based upon the two light emitting diodes.

In some embodiments, additional light emitting diodes are added in either a series or a parallel configuration to circuit 30 and still employ the concept described above. Someone skilled in the field of electronics would recognize the ability to change the values of resistor R6 and resistor R7 so that the sensed illuminating voltage applied to the input terminal of microcontroller U1 remains within the acceptable range of input parameters for the microcontroller.

FIG. 5 is a graph of a maximum current versus an ambient temperature for a light emitting diode LED. If the light emitting diode is energized such that the light emitting diode functions in a zone H representing a right side of the graph, the junction temperature will exceed 150° C., possibly damaging the junction. If the light emitting diode is energized such that the light emitting diode is in a zone L, the light emitting diode is being operated properly with the junction temperature below 150° C. which helps to realize a long life of the light emitting diode. If the light emitting diode is operated at location 1 at an ambient temperature of 68° C. at a maximum current of 1000 mA, the light emitting diode will experience a long life because the junction temperature is at approximately 150° C. However, if the current is increased beyond 1000 mA the LED will be operating in zone H with the junction temperature above 150° C. and the life of the light emitting diode is compromised. If the ambient temperature is increased from 68° C. to 100° C., the light emitting diode current should be reduced from 1000 mA to 600 mA to maintain operation within zone L. FIG. 5 graphically represents problems relating to a constant current power supply. If a 1000 mA constant current power supply is energizing an LED at location 1 at 68° C. and the ambient temperature increases, the LED begins to operate in zone H unless the 1000 mA constant current is adequately reduced. Since the constant current circuit prevents the necessary current reduction, the constant current circuit requirement inhibits the protection of the LED and exposes the LED to a junction temperature beyond 150° centigrade.

Although the above disclosed circuits 10, 20 and 30 functioned with a microcontroller, in some embodiments, some circuit configurations of the present disclosure employ components such as operational amplifiers in place of the microcontroller. In some embodiments an operational parameter such as the illuminating resistance of an LED would not have its instantaneous magnitude or value measured by a microcontroller or other device. In some embodiments an operational amplifier would compare an operational parameter with a target value and the circuit would adjust the energizing waveform in response to an unequalness between the operational amplifier and its target value.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed:

1. A lighting device comprising:
an electrical circuit configured to:
energize a light emitting diode (LED) light source having a variable illuminating resistance with a first energizing waveform for the LED light source having a first current waveform and a first illuminating resistance, and
cause a change in said first energizing waveform for effecting a change in said first current waveform in response to said LED light source having a second illuminating resistance different than said first illuminating resistance.

2. The lighting device according to claim 1, wherein:
said electrical circuit comprises a microcontroller configured to provide a pulse width modulated signal for effecting the change in said first energizing waveform.

3. The lighting device according to claim 1, wherein:
said electrical circuit comprises a microcontroller for determining said second illuminating resistance.

4. The lighting device according to claim 1, wherein:
said LED light source comprises a plurality of LEDs.

5. The lighting device according to claim 1, wherein:
said electrical circuit is configured to change said first energizing waveform in response to a difference between said first illuminating resistance and said second illuminating resistance of less than four tenths of an ohm.

6. The lighting device according to claim 1, wherein:
said LED light source having said second illuminating resistance is a result of a change in an ambient condition about said LED light source.

7. A lighting device comprising:
an electrical circuit configured to:
energize a light emitting diode (LED) light source having a variable illuminating resistance with a first energizing waveform for the LED light source having a first current waveform and a first illuminating resistance,
cause a change in said first energizing waveform in response to said LED light source having a second illuminating resistance different than said first illuminating resistance, and
determine said second illuminating resistance.

8. The lighting device according to claim 7, wherein:
said electrical circuit is configured to change said first energizing waveform in response to a difference between said first illuminating resistance and said second illuminating resistance of less than four tenths of an ohm.

9. A lighting device comprising:
an electrical circuit having a target parameter, a target relationship and configured to;
energize a light emitting diode (LED) light source having a variable illuminating resistance with a first energizing waveform for the LED light source having a first current waveform and an operating parameter of the LED light source having said target relationship with said target parameter, and
cause a change in said first energizing waveform for effecting a change in said first current waveform in response to the operating parameter not having said target relationship with said target parameter, said change in said first energizing waveform for maintaining the operating parameter having said target relationship with said target parameter.

10. The lighting device according to claim 9, wherein:
said electrical circuit comprises a microcontroller configured to provide a pulse width modulated (PWM) signal for effecting the change in said first energizing waveform.

11. The lighting device according to claim 9, wherein:
said electrical circuit comprises a microcontroller configured for maintaining said target relationship.

12. The lighting device according to claim 9, wherein:
said electrical circuit comprises a microcontroller for determining the operating parameter.

13. The lighting device according to claim 9, wherein:
said LED light source comprises a plurality of light emitting diodes (LEDs).

14. The lighting device according to claim 9, wherein:
the operating relationship not conforming to said target relationship is a result of a change of an ambient condition about said LED light source.

15. The lighting device according to claim 9, wherein:
the operating relationship is a resistive operating relationship.

16. A lighting device comprising:
an electrical circuit having a target parameter, a target relationship and configured to;
energize a light emitting diode (LED) light source having a variable illuminating resistance with a first energizing waveform for the LED light source having a first current waveform and the illuminating resistance having said target relationship with said target parameter, and
cause a change in said first energizing waveform for effecting a change in said first current waveform in response to the illuminating resistance not having said target relationship with said target parameter, said change in said first energizing waveform for maintaining the illuminating resistance having said target relationship with said target parameter.

17. The lighting device according to claim 16, wherein:
said electrical circuit comprises a microcontroller configured to provide a pulse width modulated signal for effecting the change in said first energizing waveform.

18. The lighting device according to claim 16, wherein:
said electrical circuit comprises a microcontroller for determining the illuminating resistance.

19. The lighting device according to claim 16, wherein:
said electrical circuit comprises a microcontroller configured to provide said target relationship and provide a signal for effecting the change in said first energizing waveform.

20. The lighting device according to claim 16, wherein:
said LED light source comprises a plurality of light emitting diodes (LEDs).

21. The lighting device according to claim 16, wherein:
said illuminating resistance not having said target relationship with said target resistance a result of a change of an ambient condition about said LED light source.

22. The lighting device according to claim 16, wherein:
said variable illuminating resistance is a dynamic resistance of said LED light source.
